(19) United States
(12) Patent Application Publication
(10) Pub. No.: US 2005/0062423 A1
(43) Pub. Date: Mar. 24, 2005

(54) Fluorescent lamp and lighting appliance using thereof

(75) Inventors: Yusuke Shibahara, Kanagawa-ken (JP); Masahiro Izumi, Kanagaw-ken (JP); Kiyoshi Nishimura, Kanagawa-ken (JP); Sadao Sakaguchi, Kanagawa-ken (JP)

Correspondence Address: PILLSBURY WINTHROP, LLP, P.O. BOX 10500, MCLEAN, VA, 22102, US

(73) Assignee: Toshiba Lighting & Technology Corporation, Tokyo (JP)

(21) Appl. No.: 10/948,589

(22) Filed: Sep. 24, 2004

(30) Foreign Application Priority Data
Sep. 24, 2003 (JP) P2003-331480
Mar. 11, 2004 (JP) P2004-068774

(51) Int. Cl. H01J 61/35; H01J 61/30

(52) U.S. Cl. 313/634

(57) ABSTRACT

A fluorescent lamp comprises a glass tube having the glass tube diameter of 12-20 mm which is formed on an endless shape as a whole by being partially folded, the protective coating formed on the inner wall of the glass tube, the coating containing a mixture of large particles with a mean particle size not less than 1.0 μm and fine particles with a mean particle size in the range of 10 to 100 nm, a phosphor coating formed on the protective coating, a pair of electrodes mounted in both ends of the glass tube, and a discharge medium filled in the glass tube.

### CROSS REFERENCE TO RELATED APPLICATIONS

This application is based upon and claims the benefit of priority from the prior Japanese Patent Applications JP2003-331480 filed on Sep. 24, 2003 and JP2004-223445 filed on Jul. 30, 2004, the entire contents of which are incorporated herein by reference.

### FIELD OF THE INVENTION

This invention relates to a fluorescent lamp with a partially folded glass tube and a lighting appliance using thereof.

### BACKGROUND OF THE INVENTION

There have been known fluorescent lamps of straight types, ring-shape types, and U-shapes as fluorescent lamps for general purposes. In recent years, small diameter glass tube type circular fluorescent lamps exclusively operating at a high frequency have been developed for responding to needs for saving energy and saving resources An example of such a fluorescent lamp is disclosed in JP3055769-B (hereinafter, referred to as Patent Document 1), pages 3-9 and FIG. 3. These small diameter glass tube type circular fluorescent lamps are given a class symbol, “FHC”. The small diameter glass tube type circular fluorescent lamps are superior in illumination efficiency to conventional ordinary diameter glass tube type circular fluorescent lamps with identical ring diameter. Therefore, these small diameter glass tube type circular fluorescent lamps may contribute to energy saving and saving resources.

On the other hand, it is also well known a square-shaped fluorescent lamp. For example, a 30 W square-shaped fluorescent lamp using a glass tube with a tube-diameter of 25 to 32 mm is disclosed in JP58-152365-A (hereinafter, referred to as Patent Document 2), page 2 and FIG. 2. The curvature radius of the inner wall of the folded portion of the fluorescent lamp is 20-40 mm. The outer size across the opposing straight portions of the fluorescent lamp is in the range of 190 to 220 mm. In this specification, the term “square shape” means a polygon containing “quadrangle”, and the term “glass tube-diameter” means an outer diameter of the glass tube, unless otherwise specified. The Patent Document 2 also discloses a 32 W square-shaped fluorescent lamp whose outer size over the straight portions is 260 to 290 mm.

Further, a square-shaped fluorescent lamp with a partially-folded glass tube is disclosed in JP3-59548-B (hereinafter, referred to as Patent Document 3), Col. 5 and FIG. 1.

A protective coating is formed on the inner wall of the glass tube before a phosphor coating is formed. By forming the protective coating on the inner wall of the glass tube, a planting of mercury into the glass wall of the glass tube is inhibited and thus a blackening of the glass wall is prevented. Generally, the protective coating is formed by applying a solution of fine particles, such as γ.Al₂O₃, drying and calcining the applied solution. The forming processes of the protective coating and the phosphor coating can be either of before the folding process of the glass tube or after that. However, in the small tube-diameter glass tube type square-shape fluorescent lamp, it is suitable to a mass production that the forming process of protective coating and tho phosphor coating is before the folding process of the glass tube

A technique for reducing a quantity of phosphor by using relatively large particles of phosphoric acid strontium (Sr₂P₂O₇) for the substance of protective coating is disclosed in JP2004-006185-A (hereinafter, referred to as Patent Document 4), pages 11 to 13 and FIG. 7.

However, there is a problem that in the conventional square-shaped fluorescent lamp cracks and/or peels of phosphor coatings are easy to occur approximately the folded portion. It is surmised to be caused by that the protective coating does not expand and contact in response to the expansion and contraction of glass wall at the time of the glass tube being folded. Patent Document 4 does not sufficiently refer to the relation between the cracks and/or peels of the phosphor coating which occur in the folding process and the protective coating.

On the other hand, Patent Document 1 refers that the small diameter glass tube type circular fluorescent lamp is formed by bending a glass tube with protective coating and phosphor coating prior formed on its inner wall through heating and softening in a circular shape. However, in the bending method of Patent Document 1, the whole of the phosphor coating is easily deteriorated by heat. Further alkali constituent deposits from the whole portion of the glass tube, and combines with a phosphor. Then there is a problem that the phosphor coating is seriously deteriorated.

As the small diameter glass tube type circular fluorescent lamp, the whole glass tube receives a flexible action at the time of bending. From this reason, at the time of bending, cracks and/or peels tend to occur in the protective coating and a phosphor coating, and it becomes so remarkable that a coating is thick. Therefore, they cannot be made thick enough. Therefore, there is a limit in improvement in the luminous efficiency by thickening of a phosphor coating, and an improvement of the luminous flux maintenance factor by thickening of the protective coating.

On the other hand, the fluorescent lamp of Patent Document 3 is partially folded. Therefore, there is little heat deterioration of the phosphor coating in the straight portion of most which remains.

However, as for the fluorescent lamp of Patent Document 3, since a crookedness portion has the small curvature radius compared with a circular ring form fluorescent lamp, cracks and/or peels tend to occur in the folded portion. Therefore, a phosphor coating cannot be made thick enough and high luminous efficiency is not acquired.

### SUMMARY OF THE INVENTION

The present invention has an object to provide a fluorescent lamp and a lighting appliance using the fluorescent lamp.

In order to achieving the object, a first aspect of the fluorescent lamp according to the present invention is provided with; a glass tube having the glass tube diameter of 12-20 mm which is formed on an endless shape as a whole by being partially folded. The protective coating formed on the inner wall of the glass tube, the coating containing a mixture of large particles with a mean particle size not less than 1.0 μm and fine particles with a mean particle size in the range of 10 to 100 nm; a phosphor coating formed on the protective Coating; a pair of electrodes mounted in both ends of the glass tube; and a discharge medium filled in the glass tube.

In the present invention, the terms are defined to have the following technical meanings, unless otherwise specified:

<Glass Tube>

Glass tubes are primarily formed by glass. This glass tube has two or more folded portions and at least one straight portion, constitutes endless shape mostly as a whole, and has one discharge path. For example, quadrangle form is one of this endless shape. The straight portion comprises one straight line portion and one semicircle-like portion as endless shape which is one piece, and there is form which constitutes the shape of approximately D characters as a whole.

The length of the glass tube is set up according to normal power of a fluorescent lamp.

The folded portion is formed by the following methods. That is, the protective coating and a phosphor coating are formed on a inner wall of a long straight glass tube one by one. Subsequently, both ends of the glass tube are mounted with a pair of electrodes. A predetermined part of this glass tube is heated partially, it is made to soften, folding is carried out, and it is made endless shape. The length of the folded portion should just be in the range of 5 to 50% of full length of the glass tube. The curvature radius of the inner wall of the folded portion is preferably less than a third, and more preferably less than a second of an outer curvature radius. When a shaping mold is used in the folding of the glass tube, a fold portion with an exact curvature radius may be obtained. By the way, the endless shape glass tube can be made by connecting two or more short glass tubes, after that they were folded at their midpoints.

The glass tube has one or more straight portions, in addition to the folded portions. In this case, the tube-diameter of the glass tube is made to fall in the range of 12 to 20 mm. On account of lamp characteristics such as a lamp efficiency and manufacture conditions, it is desirable that the tube-diameter of the glass tube is in the range of 14 to 18 mm. Since it is unavoidable that the tube-diameter somewhat it is not avoided at the time of folding that the tube-diameter slightly changes in folding the glass tube, it is permitted that the tube-diameter of the straight portion locally deviates from the range. A wall thickness of the glass tube at the straight portion or a moderately curving portion is desirable to be in the range of approximately 0.8 to 1.2 mm.

It is known that when the tube-diameter of the glass tube is reduced, a lamp efficiency increases. In this aspect, the tube-diameter of the straight portion and a moderately curving portion is made to fall in the range of 12 to 20 mm. This is because that when the tube-diameter is less than 20 mm, a lamp efficiency equal to or higher than that of conventional small diameter glass tube type circular fluorescent lamps can be obtained. This is also because that when the tube-diameter is less than 12 mm, a mechanical strength of the folded glass tube is extremely deteriorate, and a lamp efficiency equal to or higher than that of conventional small diameter glass tube type circular fluorescent lamps can be obtained.

In the conventional circular fluorescent lamp with a tube-diameter of 29 mm which is assigned a class symbol “FCL”, the tube-diameter should be reduced to 65% or less in order to improve lamp efficiency 10% or more. That is, the tube-diameter of the glass tube is required to be reduced to 18 mm or less. If the tube-diameter is in the range, the fluorescent lamp may be sufficiently thinned out. On account of characteristics aspects, such as a light intensity, a lamp efficiency etc., the tube-diameter of the straight portion is required to be 14 mm or more.

A glans tube in this aspect has three or more straight portions. In the square-shaped glass tube with both ends facing each other at a corner, the glass tube has folded portions one fewer than the straight portions. Further, the folded portion is formed so that the plane of the glass tube becomes substantially flat. And both ends of the glass tube are airtightly mounted with electrode mounts each of which supports an electrode, via a stem or a pinch seal portion. The glass tube is constituted in a substantially endless polygon by that the both ends face with each other.

A plurality of such polygon glass tubes can be interconnected with each other and takes single discharge path as a whole. One is an aspect that an outer polygon glass tube and an inner polygon glass tube are concentrically placed substantially in plane. Another is an aspect that two or more polygon glass tubes of substantially the same size are aligned vertically. In either aspect, firstly the protective coating and a phosphor coating are formed on the inner wall of a long straight glass tube. Then a pair of electrodes is mounted on both ends of the glass tube. After that, the glass tube is shaped in endless form by partially folded. Then the endless form glass tube with single discharge path is made by interconnecting those glass tubes through a connecting tubule. There are two aspects for such nested polygon glass tubes. One is an aspect that an outer polygon glass tube and an inner polygon glass tube are concentrically placed substantially in plane. Another is an aspect that two or more polygon glass tubes of substantially the same size are aligned vertically.

In either aspect, firstly the protective coating and a phosphor coating are formed on the inner wall of a long straight glass tube. Then a pair of electrodes is mounted on both ends of the glass tube. After that, the glass tube is shaped into a polygon form by softened with heat. Then the nested polygon glass tube with single discharge path is made by interconnecting those polygons glass tubes through the connecting tubule.

Soft glass such as soda lime glass, barium silicate glass, lead glass etc., is used for the glass tube. However, hard glass such as borosilicate glass, quartz glass tube etc., may be also used for the glass tube. It is desirable that a thickness of the glass tube is in the range of approximately 0.8 to 1.2 mm at a straight portion. However it is not limited in the range. The glass tube may be provided with a tubule for exhausting all in the glass tube and then filling a discharge gas in the glass tube.

<Square-shape>

The term “square shape” means a polygon containing “quadrangle”.

<Tube-diameter>

The term “glass tube-diameter” means an outer diameter of the glass tube.

<Protective Coating>

A protective coating is formed on the inner wall of the glass tube at a situation that large particles and fine particles exist in the coating in mixed state. The fine particle is metal oxide wherein the mean particle size is not exceeding 100 nm like a conventional protective coating substance, and preferably in the range of approximately 10-40 nm.

The mean particle size of the large particles is preferably 1 μm or more, and preferably in the range of approximately 1 to 10 μm, and more preferably in the range of approximately 2 to 7 μm. For the large particles, one or more of alkaline earth metallic salt, alpha alumina, a phosphor, etc. may be used. Further, one or more alkaline earth metallic salts selected from alkaline earth metal phosphates and alkaline earth metal aluminate may be used.

In the protective coating, the mass ratio of the large particles is preferably in the range of 50 to 90%, and more preferably in the range of 55% to 85%. Therefore, the mass ratio of the fine particles is preferably in the range of 50 to 10%, and more preferably in the range of 45% to 15%. In the protective coating, the fine particles intrude in the gaps among the large particles. Therefore, large particles are gently bonded to be able to mutually move. However, a content of fine particles is 10% or more as mentioned above. A phosphor coating has much this farther than quantity which may be added as a binder.

The quantity of fine particles is preferably in the range of 0.05 to 2 mg/cm² per unit area of the inner wall of the glass tube. The quantity of the fine particles in the folded portion is less than ±20% of the quantity of the fine particles in the straight portion. Before folding the protective coating, it may pour in and form a solution which serves as the protective coating from the end side of a straight glass tube. Further, the thickness of the protective coating is preferably in the range of approximately 3 to 25 μm. This is far thicker than the range of approximately 0.1 to 1 micrometer that is the thickness of the protective coating of the conventional circular fluorescent lamp.

<Phosphor Coating>

A phosphor coating is formed on the protective coating formed on the inner wall of the glass tube. A phosphor coating may contain approximately 1 to 3% of fine particles as a binder between phosphor particles, and a binder to the protective coating. The fine particles are preferably a metal oxide. As a metal oxide, a kind or two or more sorts may be chosen and used out of a group which consists of γ-alumina, yttria, silica, zinc oxide, titania, and ceria, for example. However, fine particles of the protective coating and fine particles in a phosphor coating may be the same substance, or a different substance.

The mean quantity of the phosphor coating is in the range of 3 to 7 mg/cm² in the principal part of the glass tube. In the folded portion, a phosphor coating is formed so that a deviation of the quantity of the phosphor coating may fall in ±15% from its mean value. When pouring the solution of the phosphor substance from the end of glass tube, the total coating thickness of the protective coating and the phosphor coating can be easily uniformizd. A phosphor coating may also be used as a multilayer coating comprising two or more layers. In this case, the thickness of a phosphor coating is uniformizd in the direction of straight side of the glass tube by carrying out by changing a phosphor solution inlet.

Now, a phosphor may be contained in the protective coating as a part of the large particles. In this case, a boundary of the protective coating and a phosphor coating becomes indistinct. However, a portion near the inner wall of the glass tube has many contents of fine particles, therefore the portion achieves a duty of the protective coating, and a far portion has few contents of fine particles and achieves a duty of a phosphor coating.

In this aspect, since the protective coating which the large particles and fine particles mixed is formed on the inner wall of the glass tube, in case the glass tube is crooked, the large particles is considered to shift under an intervention of fine particles. Irrespective of whether an action of such the protective coating is performed actually, it is hard to produce cracks and/or peels of a phosphor coating in the folded portion of the glass tube and the protective coating as a result. Therefore, the appearance of the folded portion is also kept good.

The second aspect according to the present invention is characterized by that the length of the glass tube is in the range of 700 to 3000 mm and the folded portion has an angle of approximately 90 degrees and a curvature radius at inside the outer surface of the glass tube in the range of 10 to 45 mm, so as that the glass tube is square-shaped.

This aspect specifies the length of the glass tube, and curvature radius of the folded portion. In order to obtain an illumination equivalent to that of conventional small diameter glass tube type circular fluorescent lamps, it is suitable that the length of the glass tube is in the range of 700 to 3000 mm, and more preferably in the range of 800 to 2500 mm. Discharge path length of a square-shaped fluorescent lamp is almost equal to the length of the glass tube. When curvature radius of the folded portion is in the range, a desired square-shaped fluorescent lamp may be obtained.

When curvature radius of the folded portion is in the range, there is little heat deterioration of glass tube by heating. When curvature radius of the folded portion is in the range, the straight portion may be lengthened in comparison. When curvature radius of the folded portion is in the range, it will be hard to produce cracks and/or peels of a phosphor coating in the folded portion and the protective coating, therefore the appearance f the glass tube will be kept good.

The third aspect according to the present invention is characterized by that, the large particles in the protective coating are characterized by a thing of an alkaline earth metallic salt and a phosphor consisted of a kind at least

This aspect defines a suitable substance for the large particles contained in the protective coating. It is suitable to use particles with a high reflectance of strontium phosphate (for example, Sr₂P₂O₇), calcium phosphate (for example, Ca₂P₂O₇) or aluminate of strontium or calcium, a halo calcium phosphate phosphor, etc. as an alkaline earth metallic salt.

Then, according to this aspect, a visible light transmittance of the protective coating and the reflection property of ultraviolet light may improve, and a good illumination characteristic may be obtained.

The fourth aspect according to the present invention is characterized by that the fine particles are of a metal oxide.

This aspect defines substances suitable for the fine particles contained in the protective coating. As a metal oxide, a kind of γ-alumina, yttria, silica, zinc oxide, titania, and the cerias or two or more sorts may be chosen and used, for example.

Then, according to this aspect, a visible light transmittance of the protective coating becomes good.

The fifth aspect according to the present invention is characterized by that the large particles are of a strontium phosphate and the fine particles are of a γ-alumina. The large particles of the protective coating are strontium phosphate, and the fifth aspect according to the present invention is characterized by fine particles being γ-alumina.

This aspect defines a good combination of large particles and fine particles contained in the protective coating. That is, the improvement effect which is excellent to cracks and/or peels of the protective coating and a phosphor coating while the all had a good visible light transmittance, being able to obtain the substance moreover comparatively easily and being cheap is acquired.

The sixth aspect according to the present invention is characterized by that a mass ratio of the large particles and the fine particles is given by an equation, 0.1≦a/(a+b)≦0.5 wherein “a” represents the mass of the fine particles and “b” represents the mass of the large particles.

This aspect defines a suitable mixing ratio of the fine particles and the large particles in the protective coating. That is, adhesion of the protective coating to the glass tube and binding capacity between large particles decline too much that ratio a/(a+b) of fine particles is less than 0.1. When ratio a/(a+b) of fine particles exceeds 0.5, fine particles will increase too much and, in addition to a phosphor coating and this, it will become easy to produce cracks and/or peels of the protective coating in the folded portion.

Then, according to this aspect, an action of the first aspect is acquired good by providing the configuration.

The seventh aspect according to the present invention is characterized by that a mass ratio of the large particles and the fine particles is given by an equation, 0.15≦a/(a+b)≦0.4 wherein “a” represents the mass of the large particles and “b” represents the mass of the fine particles.

This aspect defines a more suitable mixing ratio of the fine particles and the large particles in the protective coating. That is, if it is in the range, cracks and/or peels of the protective coating and a phosphor coating in the folded portion decrease very much, and a fluorescent lamp provided with the folded portion of good appearance may be obtained. When it is in the range, even if the quantity “c” of the fine particles (mg/cm²) is any the range of 0.05 to 2 mg, cracks and/or peels will decrease very much, and a fluorescent lamp provided with the folded portion of good appearance will be obtained. Here, the optimal value of a/(a+b) is approximately 0.2.

The eighth aspect according to the present invention is characterized by the quantity of the fine particles is in the range of 0.05 to 2 mg/cm².

This aspect defines a suitable configuration of the protective coating which combines a protective action to mercury of the glass tube, and cracks and/or peels prevention action of the protective coating in the folded portion of the glass tube and a phosphor coating by the protective coating. A protective action to mercury of the glass tube according that the quantity “c” of the fine particles is less than 0.05 mg/cm² to the protective coating becomes namely, less enough. When the quantity “c” of the fine particles exceeds 2 mg/cm², it will become easy to cause cracks and/or peels at an interface between the protective coating and a phosphor coating.

The ninth aspect according to the present invention is, characterized by that a fluorescent lamp comprises a glass tube having the glass tube diameter of 12-20 mm which is formed on an endless shape as a whole by being partially folded; a phosphor coating formed on the inner wall of the glass tube by applying a phosphor slurry containing fine phosphor particles and boric acid of 0.1 to 1.0 mass ratio to the mass of the fine phosphor particles to the inner wall of the glass tube, and then calcining the coating; a pair of electrodes mounted in both ends of the glass tube; and a discharge medium filled in the glass tube.

The tenth aspect according to the present invention is characterized by that a quantity of the fine phosphor particles is in the range of 4.0 to 8.0 mg/cm².

The eleventh aspect according to the present invention, is characterized by that the phosphor coating is formed by applying to the inner wall of the glass tube phosphor slurry which contains boric acid of 0.1 to 1.0 mass ratio to mass of a fine phosphor particles and this fine phosphor particles, and then calcinated.

The phosphor coating is formed by applying phosphor slurry to the inner wall of the glass tube, and then calcinated. The phosphor slurry contains boric acid (B(OH)₃) of 0.1 to 1.0 mass ratio to mass of a fine phosphor particles and this fine phosphor particles. The phosphor slurry may contain a binder which is a solvent.

The boric acid is desirable to be contained in the range of 0.3 to 0.5 mass ratio to the mass of the fine phosphor particles. Since cracks and/or peels will occur seriously in the phosphor coating in forming of folded portion when boric acid is less than 0.1 mass %, it is not desirable. On the contrary, if boric acid exceeds 1.0 mass %, water constituent undesirably remains without disconnecting in the phosphor slurry even at the time of calcining of phosphor slurry. The remaining water vaporaised as gas during lighting, and diffused in the glass tube of a fluorescent lamp to deteriorate the discharge medium and shorten the life of the fluorescent lamp.

A phosphor coating of the twelfth aspect according to the present invention is the fluorescent lamp characterized by being formed by applying a fine phosphor particles in a range of approximately 4.0 to 8.0 mg/cm² on the inner wall of the glass tube, and then calcining.

When the quantity of the fine phosphor particles is less than 4.0 mg/cm², the luminous efficiency of the phosphor coating does not undesirably turn up. On the contrary, if the spread exceeds 8.0 mg/cm², the cracks and/or peels undesirably occur a little. The quantity (mg/cm²) of fine phosphor particles is defined by a value measured for whole of the phosphor coating containing other binders, such as fine alumina particles an oxide (major inclusion being boron oxide; B2O₃) of boric acid, fine alumina particles in a phosphor slurry.

The thirteenth aspect of the present invention is a lighting appliance, comprising a lighting appliance main body; a fluorescent lamp as defined in any one of claims 1 to 10 which is attached to the lighting appliance main body; and a high frequency lighting circuit for lighting the fluorescent lamp by applying thereto a high frequency voltage of not less than 10 kHz. A high frequency lighting circuit drives lighting the fluorescent lamp by applying thereto a high frequency voltage of not less than 10 kHz.

The lighting appliance main body is for example, a ceiling mounted type, a pendant type or a wall mount type. A glove, a reflecting shade, etc. may be attached to the lighting appliance main body. The fluorescent lamp may expose from the lighting appliance main body. The lighting appliance main body may be provided with a light guide board.

The lighting appliance may be equipped with two or more fluorescent lamps in accordance with the shape or the optical characteristics of the lighting appliance. When attaching two or more fluorescent lamps, the lamps with different size and similar shape are concentrically placed so as that their curvature centered of the folded portions centers overlap at one point, and thus they are aligned in a nested combination. By the way, in the lighting appliance main body, fixing levels of the fluorescent lamps may be differentiated.

A space left between the folded portions of the adjoining fluorescent lamp becomes almost the same with the space left between the straight portions when the curvature centers of the folded portions of the fluorescent lamps attached to the lighting appliance are made to coincide with each other. Thereby, an appearance of the lighting appliance is improved and the light intensities of the fluorescent lamps are uniformized.

It is desirable that the lighting circuit supplies a lamp power with a high frequency of 10 KHz or more to the fluorescent lamps. The high frequency lighting circuit may be provided a mode selector. The mode selector may be operated to select a mode for driving the fluorescent lamps at a high efficiency, a mode for driving the fluorescent lamps at a high output. Furthermore the selector can take another mode wherein the operation of the fluorescent lamp continuously changes between the high efficiency mode and the high power output mode. A lighting situation of the fluorescent lamp is adjusted by selecting any mode on the selector. For example, the fluorescent lamps are properly used in accordance with a service condition thereof by selecting the high efficiency mode and the high power output mode of the selector.

Additional objects and advantages of the present invention will be apparent to persons skilled in the art from a study of the following description and the accompanying drawings, which are hereby incorporated in and constitute a part of this specification.

### 6. BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a plan in which expanding some of the sections and showing one embodiment of the fluorescent lamp according to the present invention;

FIG. 2 is a process chart showing the manufacturing process of the fluorescent lamp of FIG. 1;

FIG. 3 is a graph illustrating a relation between the ratio of the fine particles of the protective coating of a fluorescent lamp, and a luminous flux maintenance factor;

FIG. 4 is a plan in which expanding some of the sections and showing other embodiments of the fluorescent lamp according to the present invention;

FIGS. 5a to 5d are process charts showing the manufacturing process of the fluorescent lamp of FIG. 4;

FIG. 6 is a plan showing another embodiment of the fluorescent lamp according to the present invention;

FIG. 7 is a plan showing another embodiment of the fluorescent lamp according to the present invention;

FIG. 8 is a plan showing another embodiment of the fluorescent lamp according to the present invention;

FIG. 9 is the plan showing another embodiment of the fluorescent lamp according to the present invention;

FIG. 10 is a plan expanding and showing some fluorescent lamps of FIG. 9; and

FIGS. 11a, 11b are plan and side elevation showing one embodiment of the lighting appliance according to the present invention.

### 7. DESCRIPTION OF THE PREFERRED EMBODIMENTS

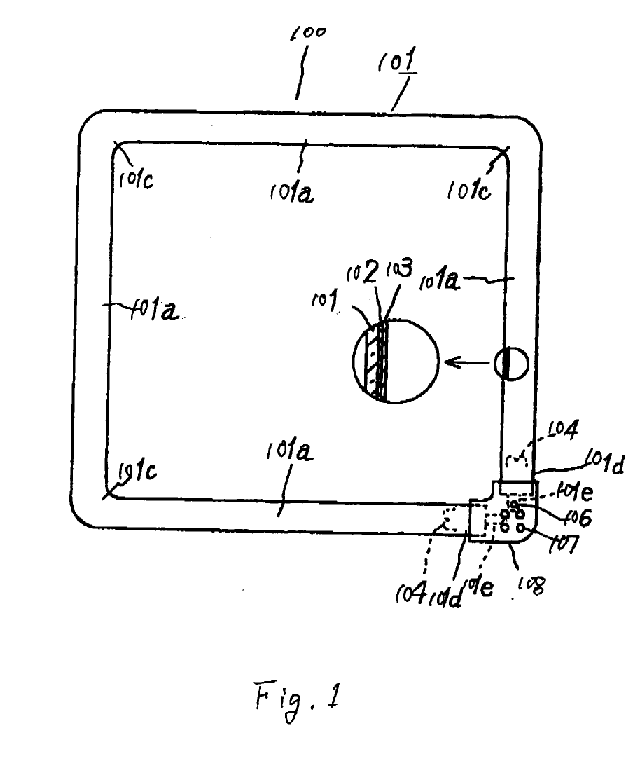

The present invention will be described in detail with reference to the attached drawings, FIGS. 1 through 12.

FIG. 1 is a plan in which expanding some of the sections and showing one embodiment of the fluorescent lamp according to the present invention. In this FIG. 1, the fluorescent lamp 100 possesses the square-shaped glass tube 101, the protective coating 102, the phosphor coating 103, the electrodes 104 and 104 of a pair, the discharge medium, and the lamp base 108. As glass tube of the square-shaped glass tube 101, soft glass tube, such as soda lime glass tube and lead glass tube, is desirable. The glass tube may be hard glass tube, such as silicic acid glass tube and quartz glass tube.

A glass tube 101 is heated partially, it is made to soften, and it is crooked, and is orthopedically operated mostly by the square as a whole. Therefore, the glass tube 101 has four straight portions 101a which accomplishes four sides of a square, three folded portions 101c which forms a corner, respectively, and the straight portions 101a and 101a located in both ends. And the both ends 101d and 101d of the glass tube 101 keep the small gap in which a lamp base is provided, and counter.

Four straight portions 101a constitute four sides of a square. The both ends 101d and 101d of the glass tube 101 counter right-angled, and it is equipped with the lamp base 108 later mentioned among them. The portion mounted the lamp base 108 constitutes the remaining one corner of the fluorescent lamp 101 remains. Crookedness section 101c is bridging straight portion 101a of an adjoining pair rightangled. Both ends 101d and 101d are closed by equipping with the flare stem of the electrode mount which is not shown, respectively, before folding the glass tube.

An electrode mount is an assembly object which consists of flare stem and tubule 101e, an electrode 104, and dent. An electrode mount is beforehand assembled by one and the end of the glass tube is equipped with them by carrying out glass tube welding of the flare portion of a flare sten. Then, wearing of tubule 101e to the glass tube 101, an electrode 104, and leadwire is performed The diaphragm section which is not shown by the mould plastic surgery at the time of equipping with a flare stem is formed on bild of ends of both glass tubes 101. It may also equip with an electrode mount by equipping with the electrode mount provided with the pinch seal and button stem which equip with the electrode mount which is not provided with other configuration, for example, stem glass tube, directly, or the bead stem via the stem concerned again.

The electrode 104, 104 are preferrably hot cathode type electrodes with emitter substance coated on a filament. However, they are not limited to those. When lighting the fluorescent lamp at high luminosity, the electrode is desirable to have a triple coil structure. The leadwire which supports an electrode 104 is supported by a button stem, a bead stem, the pinch seal section, etc.

Before folding the glass tube, after the protective coating 102 and the phosphor coating 103 which are later mentioned to the inner wall are formed and both ends are equipped with the electrodes 104 and 104 of a pair, the glass tube 101 is orthopedically operated by carrying out heating softening partially so that the abbreviation square frame which has three corners, i.e., folded portion 101c, and four [symbol] i.e., straight portion 101a and the one combination section, may be accomplished, so that it may explain in full detail later. As for length L of straight portion 101a, it is desirable that it is 200 mm or more. In this embodiment, the length L is approximately 300 mm. The tube-diameter of straight portion 101b comes out 12 to 20 mm. The coating thickness is 0.8 to 1.5 mm. In this embodiment, the tube-diameter is approximately 16 mm and the coating thickness is approximately 1.2 mm.

The protective coating 102 is formed by applying the solution used as the protective coating 102 to the inner wall of the glass tube as the section expanded in central figure part shows. A protective coating 102 is formed in the thickness of approximately in the range of 3 to 25 μm. It is included by the protective coating 102 where the large particles and fine particles are mixed. As the large particles, phosphoric acid strontium (Sr₂P₂O₇) with a mean particle size of approximately 2.5 μm is used. As fine particles, γ.Al₂O₃ (gamma-alumina) with a mean particle size of approximately 20 nm is used It is desirable for mean particle size to be able to use what is 10 nm to 10 μm, and to be 10 to 100 nm as the fine particles. Since fine particles transfers together with the glass tube surface when fine particles cannot sink into glass tube easily at the time of formation of folded portion 101c and the glass tube 101 is folded when mean particle size uses the fine particles which is 10 to 100 nm, it may inhibit that the cracks and/or peels in folded portion 101c arise. The mixing ratio of the fine particles and the large particles is 1:2 to 8. The quantity of the protective coating is two or more 4.5 mg/cm.

The protective coating 102 is formed by applying the slurry containing a metal oxide, or the fine particles and boric acid of alkaline earth metal phosphate to the inner wall of the glass tube 101, and then calcinated. Here, since boric acid is disassembled by calcining, in the protective coating 102, it exists in the state of boron oxide.

The phosphor coating 103 is formed when the glass tube 101 applies and bakes the phosphor slurry on the protective coating 102 in the state of a straight glass tube The phosphor slurry comprises boric acid of 0.1 to 10 mass %, water-soluble binder, etc. to the mass of fine phosphor particles and a fine phosphor particles. Here, since boric acid is disassembled by calcining, in the phosphor coating 103, it exists in the state (if boron oxide. A fine phosphor particles is applied two times 4.0 to 8.0 mg/cm on the protective coating 102. To the phosphor slurry, binders, such as aluminfine particles, may be added suitably.

As for the phosphor which constitutes the phosphor coating 103, it is desirable that it is a threewave luminescence type phosphor from a viewpoint of luminous efficiency. The phosphor may be wellknown phosphors, such as [symbol] phosphate phosphor.

Y₂O₃:Eu₃₊ etc. may be used near PO4,610 nm as a red system phosphor which has luminescence peak wavelength as a green system phosphor which has luminescence peak wavelength near BaMg₂Al₁₆O₂₇:Eu_{2°}, 540 nm as a phosphor of threewave luminescence type as a blue system phosphor which has luminescence peak wavelength near 450 nm, for example (La, Ce, Tb). The phosphor coating 103 is made by processes of applying a solution of three band emission fine phosphor particle in the range of 3.0 to 7.5 mg/cm², and more preferably in the range of 6.0 to 7.1 mg/cm², drying and calcining. Finally a phosphor coating with thickness in the range of approximately 10 to 30 μm is obtained.

Then, when mainly excited by ultraviolet light with a wavelength of 254 nm, the phosphor coating 103 generates the white light of correlated-color-temperature 5000 K at which it radiates by the mercury vapor mediation discharge of the discharge medium mentioned later. However, a fluorescent lamp may also be constituted using other well-known phosphors, such as a halo-phosphate phosphor.

The electrodes 104 and 104 of a pair are filament forms which consist of a triple coil of the tungsten with which the electron emission nature substance is applied. The both ends 101d and 101d of the glass tube 101 are equipped with the electrodes 104 and 104 of a pair, respectively. Electrodes 104 and 104 are retained between the point of the loadwire of the pair with which the flare stem is equipped, respectively.

In the glass tube 102, the discharge medium which consists of rare gas and mercury, such as argon, neon, or krypton, is enclosed.

A discharge medium consists of rare gas and a mercury vapor. The rare gas in this embodiment is argon (Ar) gas. The charged pressure is approximately 320 Pa. In place of argon (Ar), or together with aegon (Ar), one or more of rare gases, such as neon (Ne) and krypton (Kr), may also be filled. A mercury vapor is supplied from the amalgam 106 remaining in tubule 101e. Amalgam 106 is amalgam for mercury vapor pressure control which consists of bismuth (Bi)-tin (Sn)-lead (Pb) system.

Or amalgam 106 may be stuck to the base of for example, a flare stem. Amalgam may be filled in the glass tube 101 in freely movable. Mercury may also be enclosed as liquefied pure-water silver, without using amalgam.

Amalgam is the alloy of mercury. Amalgam may be what kind of form, such as a pellet type, a column, and the shape of a board. For example, amalgam, such as zinc-mercury, may be enclosed for fixed quantity enclosure of mercury. When the amalgam for mercury vapor pressure control is placed into the glass tube, a fluorescent lamp may be turned on also in the state where an ambient temperature is fairly high. The amalgam 106 of this embodiment is amalgam for mercury vapor pressure control of a bismuth (Bi)-tin (Sn)-lead (Pb) system. Still another amalgam may be used auxiliary. This auxiliary amalgam is constituted as an indium (In) coating plated by the substrate of stainless steel. The indium (In) reacts with the mercury vapor in the glass tube 101, and forms amalgam. Especially this auxiliary amalgam may supply a mercury vapor at the time of starting, and may speed up a luminous flux standup. As the section form of folded portion 101c of the glass tube 101 is built in the shape of a triangle, or square form and the coldest portion is formed on the portion concerned, without using amalgam 106, fluid mercury may also be used in a top. That is, if the section of folded portion 101c constitutes the shape of a triangle, and square form and a corner is formed, that will serve as the optimal high coldest portion of a cooling effect, and the mercury vapor pressure in the glass tube will be adjusted aspectrately. Therefore, temperature characteristics may be raised, without using amalgam.

The glass tube 101 may be constituted so that the coldest portion may be formed on at least one folded portion 101c at the time of lighting of a fluorescent lamp. The maximum cold section is formed on the part with the lowest temperature of the glass tube at the time of lighting of a fluorescent lamp 100. What is necessary is in short, just to form so that it may be hard to carry out the rise in heat of the form of folded portion 101c at the time of lighting. For example, they have a structure which forms the space distant from the discharge path, or a structure for efficiently radiates heat.

It is also possible to form the coldest portion in 101d of ends of the glass tube because more than predetermined length separates the fixing point of an electrode 104,104 from 101d of ends of the glass tube. For example, it becomes possible by setting at least one electrode height (length from the end of the glass tube to an electrode fixing point) to 30 mm or more to form the coldest portion in the request part of the end of the glass tube. When it is possible to control the maximum cold section to a desired temperature, it will become possible to secure the optimal mercury vapor pressure, without using the amalgam for mercury vapor pressure control, even if an ambient temperature is high, and it will become possible to raise a lamp efficiency by one coating

The lamp base 108 is provided with four lamp base pins 107 by which L-letter shape is electrically connected with nothing and an electrode 104,104 so that between luid of both ends of the glass tube 101 might be bridged. The lamp base pin 107 is connected to the leadwire (not shown) currently drawn from the both ends 101d and 101d of the glass tube 101. Therefore, in this embodiment, the portion mounted with the lamp base 108 constitutes one corner of a quadrangle.

A lamp base 108 may be configuration which supports the glass tube 101 by mechanical connection with electric supply means, such as a socket.

Now, the manufacture method of the glass tube 101 used for the fluorescent lamp 100 of this embodiment will be explained.

First, the straight glass tube-like glass tube 101 is prepared as usual, and the slurry which contained alumina and boric acid in the inner wall of the glass tube 101 is applied and baked. Thereby, the protoective coating 102 is formed.

Subsequently, from on the protective coating 102, the phosphor slurry which comprised boric acid of 0.1 to 1.0 mass %, water soluble binder, etc. to the mass of a fine phosphor particles and a fine phosphor particles is applied on the protective coating 102, and then calcinated. Thereby, the phosphor coating 103 is formed.

Thus, both ends 102d and 102d are equipped with tubule 101e using obtained straight glass tube 2a, and it equips with an electrode 104,104 in straight glass tube 101a via the flare stem (not shown) which introduces the lead wire of a pair.

Straight line-like glass tube 101a is 1200 mm in full length. Bending of this glass tube 101a is carried out by three predetermined places.

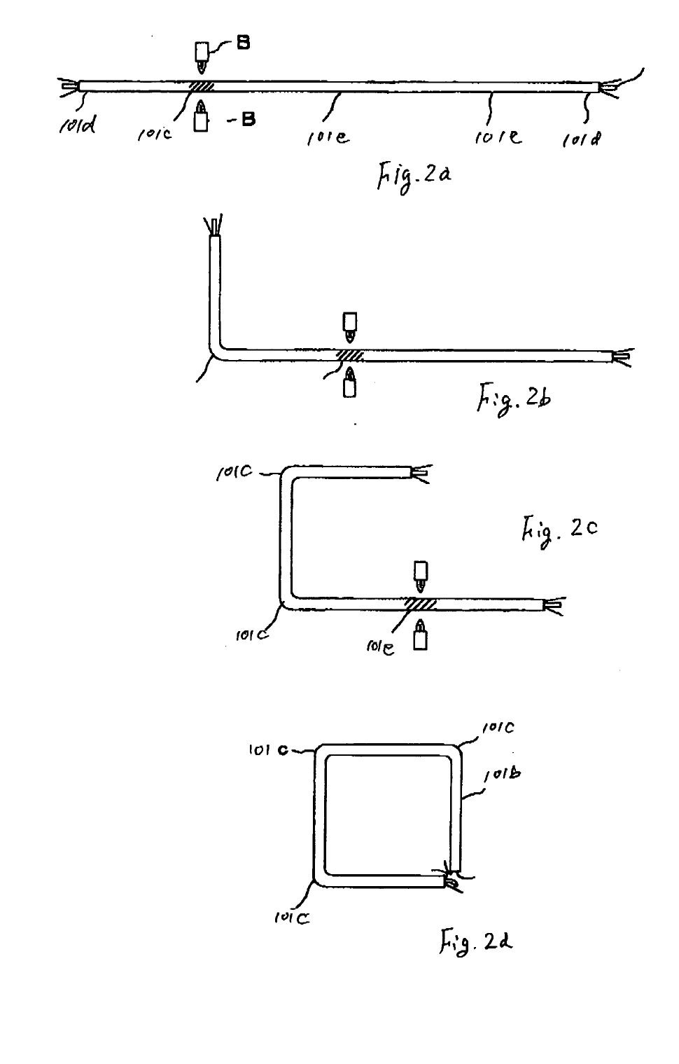

FIGS. 2a to 2d are process charts showing the process of forming the square-shaped glass tube 101 of FIG. 1.

First, as shown in FIG. 2a, the formation schedule part of first folded portion 101c is heated and softened with a gas burner B. Subsequently, folding is performed using an operated-orthopedically type and first folded portion 101c is formed so that the angle which straight portion 101a accomplishes as shown in FIG. 2b may become approximately 90 degrees. Subsequently, as a gas burner B performs heating softening, folding, and mould plastic surgery similarly and the formation schedule part of second folded portion 101c is shown in FIG. 2c, second folded portion 101c is formed. Finally, as are shown in FIG. 2e, and a gas burner B performs heating softening, folding, and mould plastic surgery similarly and the formation schedule part of third folded portion 101c is shown in 2d of figures, third folded portion 101c is formed In this way, the formed square-shaped glass tube is exhausted from tubule 101e, mercury is enclosed, and the square-shaped glass tube 101 is completed.

By the way, since the circular fluorescent lamp is made by bending circularly in heating to soften the whole of the glass tube, after the phosphor coating is formed on the inner wall of the glass tube in a straight condition. Thus the glass tube is wholly expanded a little at the time of bending. Then there arises a fear that cracks and/or peels might occur in the phosphor coating formed before. For this reason, the circular fluorescent lamp is difficult to be unable to make a coating thickness of a phosphor coating large beyond a predetermined value, but to raise the light intensity.

On the other hand, since straight portion 101a is not extended virtually, even if the fluorescent lamp 100 of one embodiment of the present invention thickens the phosphor coating 103, it does not have a possibility that cracks and/or peels may arise on the phosphor coating 103 in folding.

The core is opened for free passage via folded portion 101c, and as for straight portion 101a, single discharge path is formed so that the center of the abbreviation square which straight portion 101a forms between the electrodes 104,104 of the pair mentioned later may be surrounded.

In the still more nearly another embodiment, since the phosphor coating 103 is formed by applying to the inner wall of the glass tube 101 the phosphor slurry which contains the boric acid of 0.1 to 1.0 mass % to the mass of a fine phosphor particles and a fine phosphor particles, and then calcinated, luminous efficiency is high and the fluorescent lamp 100 which inhibited tho cracks and/or peels of the phosphor coating 103 in folded portion 101c may be offered. That is, if it bakes after applying the phosphor slurry containing boric acid to the inner wall of the glass tube 101, as described above, it will decompose and the boric acid contained in the phosphor slurry will serve as boron oxide.

In case folding of the glass tube 101 is carried out, it softens with heating, and this boron oxide may be expanded and contracted Therefore, the phosphor coating 103 of the folded portion expands and contracts, and the cracks and/or peels of the phosphor coating 103 in folded portion 101c are inhibited. When there is too little quantity of boron oxide, it will be easy to cause cracks and/or peels of the phosphor coating 103. When there is too much quantity of boron oxide, the moisture contained in the phosphor slurry will remain without disconnecting at the time of calcining. Since the phosphor slurry which contains the boric acid of 0.1 to 1.0 mass % to the mass of a fine phosphor particles in this embodiment is applied, those problems are also solved So, luminous efficiency is high and the fluorescent lamp 100 which inhibited the cracks and/or peels of a phosphor coating in folded portion 101c may be offered.

In the still more nearly another embodiment, since the phosphor coating 103 contains boron oxide, the fluorescent lamp 100 with a quick standup may be offered. That is, since a mercury vapor did not evaporate in the lighting starting period for several minutes after a lighting start but it has entered between fine phosphor particles, the standup of lighting is late. On the other hand, in this embodiment, since boron oxide has entered between phosphor particles, the intrusion of mercury into the gaps between fine phosphor particles may be inhibited. So, immediately after a lighting start, since a mercury vapor evaporates at an early stage, the fluorescent lamp 100 with a quick standup may be offered.

In the still more nearly another embodiment, since the phosphor coating 103 is formed by applying a fine phosphor particles 4.0 to 8.0 mg/cm² on the protective coating 102, and then calcinated, luminous efficiency is more high and the fluorescent lamp 100 which inhibited certainly the cracks and/or peels of the phosphor coating 103 in folded portion 101c may be offered. That is, when the quantity of fine phosphor particles is less than 4.0 mg/cm², the luminous efficiency decreases. And when the quantity of a fine phosphor particles exceeds 8.0 mg/cm², cracks and/or peels occur in the phosphor coating even if boric acid is contained in the phosphor slurry. On the other hand, since the fine phosphor particles which contained the boric acid of 4.0 to 8.0 mg/cm² in this embodiment is applied, those problems are solved. So, luminous efficiency is more higher and the fluorescent lamp 100 which inhibited certainly the cracks and/or peels of the phosphor coating 103 in folded portion 101c may be offered.

In the still more nearly another embodiment, since the protective coating 102 is formed by applying the slurry containing boric acid to the inner wall of the glass tube 101, and then calcinated, the fluorescent lamp 100 which inhibited the cracks and/or peels of the protective coating 102 in folded portion 101c may be offered. That is, since the protective coating reflects ultraviolet radiation inside, a certain quantity of coating thickness is required for it, but if coating thickness of the protective coating is thickened, cracks and/or peels will occur in the folded portion like a phosphor coating.

On the other hand, since the protective coating 102 is formed by applying to the inner wall of the glass tube 101 the flurry which contains boric acid in this embodiment, and then calcinated, such a problem is solved. So, the coating thickness of the protective coating 102 is thick, and may offer the fluorescent lamp 100 which inhibited the cracks and/or peels of the protective coating 102 in folded portion 101c. By having inhibited cracks and/or peels of the protective coating 102, cracks and/or peels of the phosphor coating 103 may also be inhibited, and the reaction of the glass tube 101 and mercury may be inhibited certainly.

In the still more nearly another embodiment, although folded portion 101c is formed by folding, since it is not necessary to heat too much, even if it applies the phosphor coating 103 before formation of folded portion 101c, a phosphor hard to be thermally deterioated, and a luminous flux maintenance factor is greatly improved except folded portion formation schedule section 101e of straight glass tube 101a.

A fluorescent lamp 100 may be made into the following sizes. In the square-shaped fluorescent lamp with which illumination efficiency is equivalent to the ordinary 30 W circular fluorescent lamp, it is made that the length of the glass tube 101 is 225 mm, the maximum inside dimension is 192 mm, the tube-diameter is 16 mm and the wall thickness of the glass tube 101 is 1.0 mm. This fluorescent lamp is operated with the rated lamp wattage of this fluorescent lamp of 20 W, and the lamp electric power at a high-output characteristics of 27 W.

In the square-shaped fluorescent lamp with which illumination efficiency is equivalent to the ordinary 32 W circular fluorescent lamp, it is made that the length of the glass tube 101 is 299 mm, the maximum inside dimension is 267 mm, the tube-diameter is 16 mm and the wall thickness of the glass tube 101 is 1.0 mm. This fluorescent lamp is operated with the rated lamp wattage of this fluorescent lamp of 27 W, and the lamp electric power at a high-output characteristics of 38 W.

In the square shaped fluorescent lamp with which illumination efficiency is equivalent to the ordinary 40 W circular fluorescent lamp, it is made that the length of the glass tube 101 is 373 mm, the maximum inside dimension is 341 mm, the tube-diameter is 16 mm and the wall thickness of the glass tube 101 is 1.0 mm. This fluorescent lamp is operated with the rated lamp wattage of this fluorescent lamp of 34 W, and the lamp electric power at a high-output characteristics of 48 W.

The coating thickness of the protective coating 102 formed on the inner wall of the square-shaped glass tube 101 is set to 0.5 μm or more. The phosphor coating 103 is formed on the protective coating 102. The quantity of mercury filled in the glass tube 101 is desirable 0.15 mg/W or more.

The mercury filled in the glass tube 101 is exhausted by reacting with the alkali constituent which deposited from the glass tube of a phosphor or the glass tube, changing to mercuric compounds or devoting oneself into glass tube during lighting of a fluorescent lamp, and the quantity used as a mercury vapor decreases gradually. Mercury consumption has a relation mostly proportional to the magnitude of lamp electric power. For this reason, more mercury is filled in the glass tube 101 in consideration of the quantity exhausted within the glass tube 101 by life attainment according to lamp electric power. However, on account of environment influence of a lamp manufacturing process and waste of the fluorescent lamp, the amount of mercury filled is desirable to be reduced as much as possible.

The effect which inhibits the phenomenon in which mercury is driven in the reaction of the alkali constituent in the glass tube of the glass tube and mercury and into glass tube as the coating thickness of the protective coating 102 is 0.5 μm or more may be expected, and the consumption of the mercury under lamp lighting may be reduced. Since straight portion 101a is not extended virtually, even if the fluorescent lamp 100 of this embodiment makes large to 0.5 μm or more coating thickness of the protective coating 102 formed on straight glass tube 101a, according to a folded portion formation process, there is no possibility that a crack etc. may arise in the protective coating 102 of the straight portion, and it may demonstrate the function of the protective coating 102 enough.

Mercury consumption is conjointly reduced greatly with not being directly heated to the grade in which straight portion 101a softens the coating thickness of the protective coating 102 with 0.5 μm or more, then the function of the protective coating 3. Thereby, it is confirmed that it is possible to continue lighting, without mercury being drained until it continued till lamp rated-life time also considering the quantity of enclosure mercury per lamp electric power as 0.15 or less mg/W. Thus, it becomes possible by setting coating thickness of the protective coating 102 to 0.5 μm or more to satisfy a rated life also as 0.15 or less mg/W approximately the quantity of enclosure mercury per lamp electric power.

It becomes possible to reduce phosphor by using fine particles with a high ultraviolet radiation reflectance for the protective coating 102, without reducing the light intensity. This is an effect acquired by forming the protective coating 102 by using the fine particles of a mettal oxide with the high reflecting effect of ultraviolet radiation with a wavelength of 254 nm, and the high permeability of visible light, or metal phosphate as a principal constituent. That whose reflectance of ultraviolet radiation with a wavelength of 254 nm is 60 % or more to it of barium sulfate as this fine particles, for example is desirable. That whose reflectance in the wavelength of 780 nm is 60% or less to it of barium sulfate is desirable.

A specific surface area is more than 80 m2/g, and as for the metal oxide fine particles which constitutes the protective coating 102, it is desirable for the spread of the fine particles per unit area of the inner wall of the glass tube to be 0.01 to 0.8 mg/cm² in order to prevent the reaction of the fine phosphor particles of a phosphor coating, and the alkali constituent in glass tube, and coloring of glass tube. The effect is remarkable when wall load lights up by two or more 0.05 W/cm especially.

Wall loading means the lamp input electric power per surface wall surface area of the glass tube 101. The fine phosphor particles of a phosphor coating and the alkali constituent in glass tube react, and the phosphor coating is easy to be deteriorated over time, so that there is so much calorific power that the value of this wall load is large and the temperature at the time of lighting is high.

Since it becomes easy to color glass tube by the alkali constituent in glass tube depositing, and reacting with mercury etc. or driving in mercury into glass tube, since the radiant quantities of short wavelength ultraviolet radiation increase so that the value of wall load is large, a visible light transmittance is in the tendency to fall remarkably. Here the phrase “surface wall surface area of the glass tube” means whole surface wall surface area of the glass tube, as well as the surface wall surface area along the discharge path.

Since the straight portion is not extended virtually, even if the fluorescent lamp with which the quantity of the protective coating 102 provided on the inner wall of the straight glass tube 111a is increased, according to a folded portion formation process, there is no possibility that a crack etc. may arise in the protective coating 102 of straight portion 101a, and it may demonstrate the function of the protective coating 102 enough.

Since the specific surface area is more than 80 m2/g, the protective coating 102 serves as very precise structure, and an alkali constituent, mercury, etc. which deposited from the glass tube 101 are blocked with the protective coating, and become possible to effectively inhibit deterioration of the phosphor coating 103 over time and coloring of the glass tube 101.

Now, the action of this embodiment will be explained. High frequency electric power is inputted from a lamp base 108, and a fluorescent lamp 100 is turned on by the low-pressure mercury vapor discharge in the glass tube 101. As for more than 20 W and lamp current, a fluorescent lamp 1 is turned on so that lamp input electric power may be set to 200 mA or more, wall load may become two or more 0.05 W/cm and a lamp efficiency may set it 501 or more m/W. The lamp current density which are lamp current per crosssectional area of straight portion 2b are two or more 75 mA/cm. In this embodiment, as for lamp input electric power, 380 mA and the lamp efficiency of 50 W and lamp current are 901 mA/W.

Although the temperature of the glass tube 101 rises at approximately 80 degree-C. at the time of lighting of a fluorescent lamp 100, since the amalgam of a bismuth (Bi)-tin (Sn)-lead (Pb) system is accommodated in tubule 101e, it enables it for the vapor pressure in the glass tube to be controlled by the mercury vapor pressure characteristics of this amalgam by the proper value, and to switch on the light with a high lamp efficiency with them.

In this embodiment, although the glass tube 101 is formed by that a straight glass tube 101a is partially folded, it is made by that small L-shaped glass tubes 101 are connected together at their facing ends.

By the way, the glass tube may be made by glass with lead virtually excluded, sodium oxide not exceeding 1.0 mass %, and that whose softening temperature not exceed 720 degree-C. may be used for the glass tube 101. Here, the phrase “lead virtually excluded” means that the lead constituent may be slightly contained as impurity. The lead constituent is preferably less than 0.1 mass %. It is ideal that he lead constituent is completely excluded. The phrase “sodium oxide not exceeding 0.1 mass %” includes a situation that sodium oxide is completely excluded.

It is undesirable that sodium oxide exceeds 0.1 mass %. because when sodium oxide exceeds 0.1 mass % sodium depositing from the glass affects a light intensity of the light intensity of the fluorescent lamp 100. By the configuration which does not contain lead virtually, below in 1.0 mass %, sodium oxide may carry out, and the softening temperature may adjust and obtain K₂O and Li₂O, and CaO, MgO, BaO, and SrO as glass tube 720 degree-C. or less. Here, the softening temperature is the temperature corresponding to the viscosity of glass of 107.65 dPa.s.

When a sodium oxide exceeds 0.1 mass %, a large amount of sodium will deposit from the glass tube 101 during lighting. The depositing sodium reacts to mercury filled in the glass tube 101 and adheres to the inner wall of the glass tube 101. Thus the deposit sodium causes a problem of reducing a visible light transmittance, deteriorating the phosphor substance of the phosphor coating 103 by reacting to reduce the intensity of visible light. Since especially ordinary soda lime glass tube is doing 15 to 17 mass % content of a sodium oxide, there is much deposition of sodium and its output fall of visible light is remarkable.

Then, if sodium oxide applies a phosphor to the glass tube 101 of the shape of a straight glass tube which consists of glass tube whose softening temperature is 720 degree-C. or less, for example, 692 degree-C., below by 0.1 mass % and forms the folded portion after that, the sodium which deposits from glass tube will decrease extremely and the fall of the quantity of visible luminescence by the reaction of sodium will be inhibited. Since the softening temperature is 720 degree-C. or less, the cooking temperature at the time of folded portion formation is stopped low, the heat deterioration of a surrounding phosphor decreases, and the light intensity improves.

Now, a comparison test ran for samples according to this embodiment (hereinafter referred to as present invention test sample) and comparative samples will be explained. In this comparison test, presence of cracks in the phosphor coating 103 at the folded portion (hereinafter, referred to as folded portion crack), total luminous flux, and performance, after a continuous lighting test of 1200 hours, for present invention test samples and comparative samples, the phosphor coating 103 in the folded portion 101c of the glass tube 101 were investigated. A result of the comparison test will be shown in the following Table 1. The present invention test samples and the comparative samples are the fluorescent lamps with the same specification except following differences of constitution in the protective coating 102 may enumerate below.

Present invention test sample 1 (Sample I): fine particles γ.Al₂O₃, large particles Sr₂P₂O₇, mixture ratio 1:4, 5 μm of coating thickness Present invention test sample 2 (Sample II): fine particles γ.Al₂O₃, large particles Sr₂P₂O₇, mixture ratio 1:4, 10 μm of coating thickness.

### COMPARATIVE EXAMPLE 1

(Sample III): fine particles γ.Al₂O₃, large particles . . . 0.1 μm of coating thickness.

### COMPARATIVE EXAMPLE 2

(Sample IV): fine particles γ.Al₂O₃, large particles . . . 1 micrometer of coating thickness

The evaluation meaning of a sign over a folded portion crack is as follows among Table 1.
AA: Very Good; A: Good; C: Poor

Total luminous flux is a relative value on the basis of the value of the present invention test sample 1 at the time of 100-hour continuation lighting.

Performance is a ratio to the lighting initial value of total luminous flux.

TABLE 1

| | Folded | Total | |
|---|---|---|---|
| Test Sample | Portion | Luminous | |
| No. | Crack | Flux (&) | Performance |
| Sample I | AA | 100 | 78 |
| Sample II | A | 102 | 80 |
| Sample II | A | 97 | 70 |
| Sample IV | C | 95 | 65 |

A fluorescent lamp 100 may be made into the following sizes in this embodiment. That is, in the square-shaped fluorescent lamp with which illumination efficiency is equivalent to the ordinary 30 W circular fluorescent lamp, it is made that the lengthe of the glass tube 101 is 225 mm, the maximum inside dimension is 192 mm, the tube-diameter is 16 mm and the wall thickness of the glass tube 101 is 1.0 mm This fluorescent lamp is operated with the rated lamp wattage of this fluorescent lamp of 20 W, and the lamp electric power at a high-output characteristics of 27 W.

Further, in the square-shaped fluorescent lamp with which illumination efficiency is equivalent to the ordinary 32 W circular fluorescent lamp, it is made that the length of the glass tube 101 is 299 mm, the maximum inside dimension is 267 mm, the tube-diameter is 16 mm and the wall thickness of the glass tube 101 is 1.0 mm. This fluorescent lamp is operated with the rated lamp wattage of this fluorescent lamp of 27 W, and the lamp electric power at a high-output characteristics of 38 W. In the square-shaped fluorescent lamp with which illumination efficiency is equivalent to tho ordinary 40 W circular fluorescent lamp, it is made that the length of the glass tube 101 is 373 mm, the maximum inside dimension is 341 mm, the tube-diameter is 16 mm and the wall thickness of the glass tube 101 is 1.0 mm. This fluorescent lamp is operated with the rated lamp wattage of this fluorescent lamp of 34 W, and the lamp electric power at a high-output characteristics of 48 W.

Now, an operation in this embodiment will be explained. A fluorescent lamp 100 will be turned on by the low-pressure mercury vapor discharge occurring in the glass tube 101, when a high-frequency voltage is applied between the pair of electrodes 104, 104 via a lamp base 108. The fluorescent lamp 100 is operated so as that the lamp power of 20 W or more, the lamp current of 200 mA or more, a wall load of 0.05 W/cm² or more, and a lamp efficiency of 50 lm/W or more are established. The lamp current density which is the lamp current per crosssection of the straight portion 101b is 75 mA/cm² or more.

In this embodiment, the lamp electric power is 50 W; the lamp current is 380 mA; and the lamp efficiency is 90 lm/W. Here, since Sr₂P₂O₇ (phosphoric acid strontium) used for the protective coating 102 has high reflectance characteristics, even if the coating thickness of the protective coating 102 is set in the range of 5-20 μm, and the coating thickness of the phosphor coating 103 is set in the range of 8-20 μm, sufficient illumination is obtained. Optical output sufficient in comparison as for 5 to 15 μm is obtained in the coating thickness of the protective coating 102. For this reason, the quantity of the phosphor used is reducible. Since the protective coating 102 and the phosphor coating 103 are applied in the state of the aqueous solution which does not contain the organic system binder and are formed, luminous efficiency is high and the luminous flux maintenance factor is also excellent

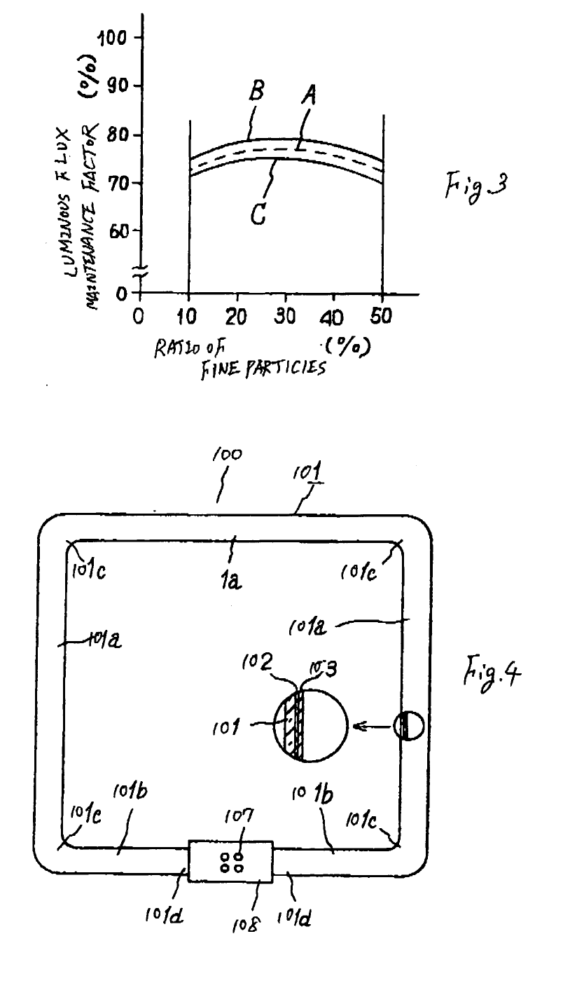

Now, in this embodiment, test lamp samples with various quantities of the fine particles of the protective coating 102 were tested for presence of peels of the phosphor coating 103, A result of the test will be explained in reference to following Table 2 and FIG. 3.

Test procedure: Visual observation after continuation lighting of 9000 hours Evaluation result: AA: Very Good (No peels observed absolutely); A: Good (Peels hardly observed) B: Small number of peels observed; C: Large number of peels observed;

Ratio of fine particles: mass % taken by {a/(a+b)} wherein “a” represents the mass of the large particles and “b” represents the mass of the fine particles.

TABLE 2

| Ratio of | Quantity of Fine Particles | | |
|---|---|---|---|
| Fine | 0.05 | 0.1 | 0.2 |
| Particles | mg/cm² | mg/cm² | mg/cm² |
| 0 | C | C | C |
| 1 | B | B | B |
| 10 | A | A | A |
| 20 | AA | AA | AA |
| 30 | AA | AA | A |
| 40 | A | A | A |
| 50 | A | A | A |
| 60 | A | B | B |
| 80 | B | C | C |

FIG. 3 is a graph which shows the luminous flux maintenance factor of the fluorescent lamp with which the comparison test is presented. In FIG. 3, horizontal axis represents the ratio of the fine particles (%); vertical axis represents the luminous flux maintenance factor at the time of 9000-hour from the start of lighting to the total luminous flux (lm), assumed as 100%, from at the time of 100-hour from the start of lighting.

In the drawing, Curve A represents a fluorescent lamp in which the quantity of the fine particles is 0.05 mg/cm². Curve B represents a fluorescent lamp in which quantity of the fine particles is 0.1 mg/cm². Curve C represents a fluorescent lamp in which quantity of the fine particles is 0.2 mg/cm².

As seen from FIG. 3, in either of fluorescent lamps A, B and C, the luminous flux maintenance factor exceeds 70% over the range 10-50% of the ratio of the fine particles. Further, the luminous flux maintenance factor rises, in the order of the fluorescent lamp C, fluorescent lamp A, fluorescent lamp B.

Referring now to FIGS. 4 to 7, some other embodiments of the fluorescent lamp according to the present invention will be explained. In FIGS. 4 to 7, the same mark is attached approximately the same portion as FIG. 1, and explanation of the portion is omitted.

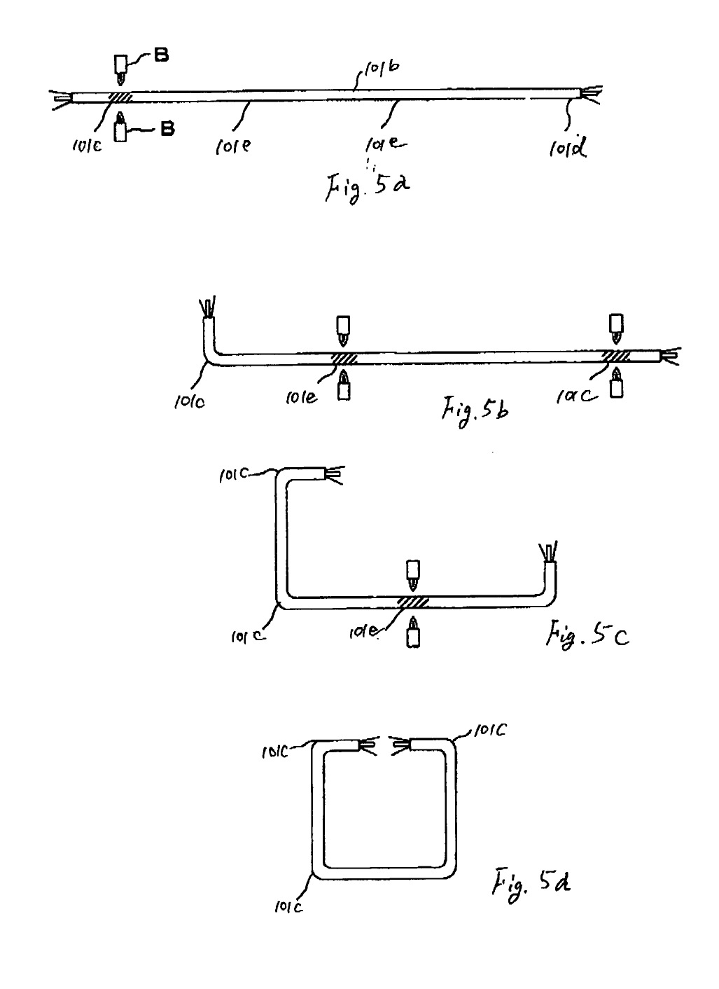

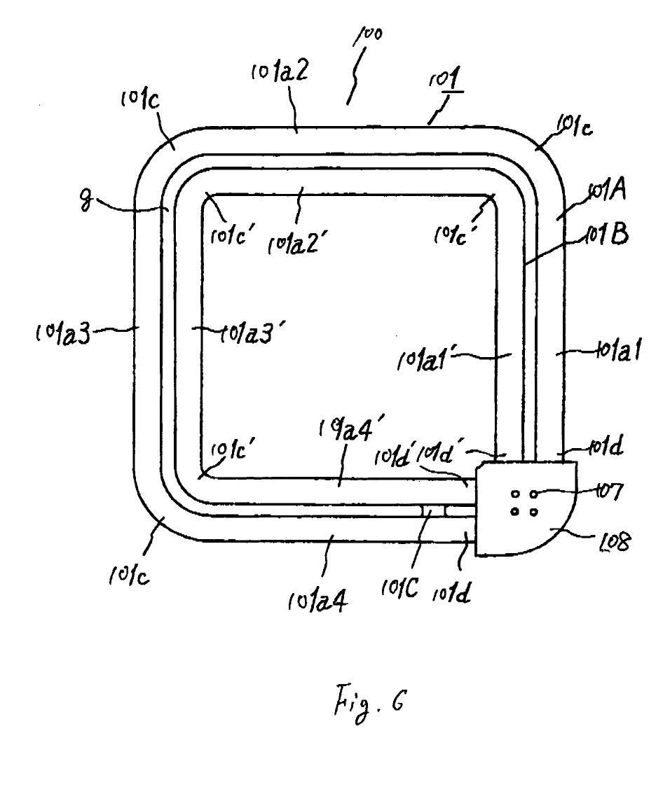

FIG. 4 is a plan in which expanding some of the sections and showing other embodiments of the fluorescent lamp according to the present invention. This embodiment is equipped with the lamp base 108 in the square center of one side. For this reason, as for the glass tube 101, 101d of ends of straight portion 101b of a pair has countered in the shape of a straight line. And between both ends 101d and 101d is bridged with the lamp base 108. FIGS. 105a to 5d of figures are process charts showing the process which creates the square-shaped glass tube 101 of FIG. 4.

First, as shown in FIG. 5a, the formation schedule part of first folded portion 101c is heated and softened with a gas burner B. Subsequently, as shown in FIG. 5, folding is performed using an operated-orthopedically type and first folded portion 101c is formed so that the angle which straight portion 101a accomplishes as shown in FIG. 5b may become approximately 90 degrees. Subsequently, as a gas burner B performs heating softening, folding, and mould plastic surgery similarly and the formation schedule part of second folded portion 101c and the formation schedule part of fourth folded portion 101c which flew one are shown in FIG. 5c, second and third folded portion 101c is formed. Finally, as are shown in FIG. 5e, and a gas burner B performs heating softening, folding, and mould plastic surgery and the formation schedule part of third folded portion 101c between they second and fourth folded portion 101c is shown in 5d of figures, third folded portion 101c is formed. In this way, the formed square-shaped glass tube is exhausted from tubule 101e, mercury is enclosed, and a fluorescent lamp 100 is completed.

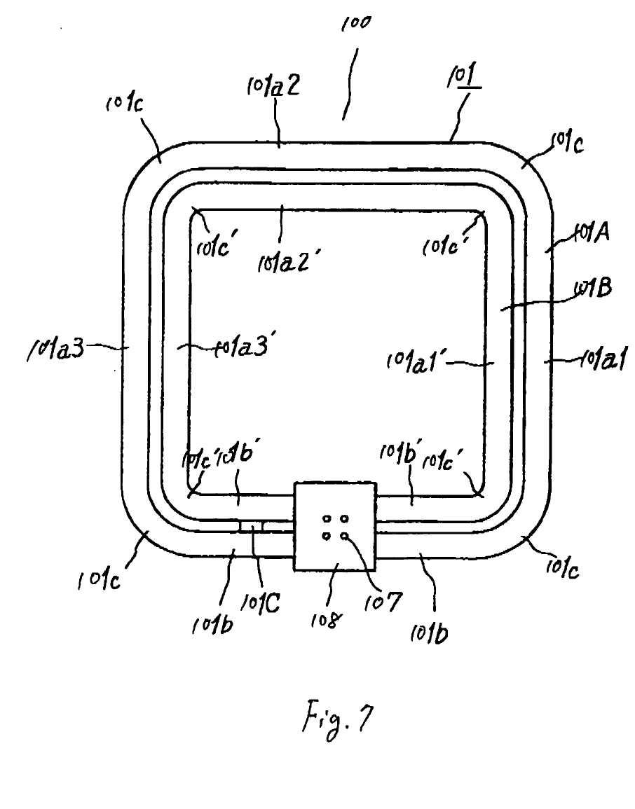

FIG. 6 is a plan showing another embodiment of the fluorescent lamp according to the present invention. As for this embodiment, the glass tube 101 is provided with this cardiac double ring structure.

That is, the glass tube 101 constitutes the glass tube which is provided with the outside glass tube 101A configured in the same plane, the inside glass tube 101B, and connecting portion 101C, and has one folded discharge path. Outside glass tube 101A and the inside glass tube 101B have the same tube-diameter, and are making the shape of a similar square. Free passage section 101C is opening the outside glass tube 101A and the inside glass tube 101B for free passage, and forms one discharge path in the core of the glass tube 101. One end of the discharge path passes the straight portion 101a2, 101a3 from 101d of one ends of the straight portion 101a1 in the outside glass tube 101A, and a discharge path leads to 101d of ends of another side of the straight portion 101a4. Furthermore, the discharge path goes into the other end 101d′ of the inside glass tube 101B via the connecting portion 101C, and reaches the other end 101d of the straight portion 101a1! via straight portions 101a4′, 101a3′, 101a2′.

The position in which connecting portion 101C is arranged is set up so that it may leave the distance of 10 to 40 mm from the nose of cam of the outside glass tube 101A and the inside glass tube 101B. The space into which a discharge arc does not advance is formed on 101d of ends of the outside glass tube 101A and the inside glass tube 101B of it. In order to make easy formation of connecting portion 101C, it is desirable to set the crevice g formed between the outside glass tube 101A and the inside glass tube 101B as 5.0 to 10.0 mm. As for connecting portion 101C, it is desirable to be formed on the position hidden with a lamp base 108.

A length of one side of the square of the outside glass tube 101A is 250 mm or more, and, as for a length of one side of the square of the inside glass tube 101B, it is desirable that it is 200 mm or more. It is desirable for the tube-diameter of both the glass tubes 101A and 101B to be 12 to 20 mm, and for thickness to be 0.8 to 1.5 mm. In a practical embodiment, the length of the straight portions, i.e., the length of each tside of the square of the outside glass tube 101A is 300 mm, the length of the straight portions of the inside glass tube 101B is 250 mm, and their tube-diameters are the same as 14 mm, and their wall thicknesses are the same as 1.2 mm.

The folded portions 101c, 101c′ of the outside glass tube 101A and the inside glass tube 101B are desirably in the following ranges. That is, it is desirable that the outer curvature radius of tho outside glass tube 101A is in the range of 45 to 70 mm, the inner side curvature radius is in the range of 30 to 55 mm, for the outer curvature radius of the inside glass tube 101B is in the range of 25 to 45 mm, and the inner side curvature radius is in the range of 13-20 mm. In a practical embodiment, the outer curvature radius of the outside glass tube 101A is 56.5 mm, this inner side curvature radius is 40 mm, the outer curvature radius of the inside glass tube 101B is 31.5 mm, and this inner side curvature radius is 15 mm. The tube-diameters of the folded portions 101c and 101c′ are desirable to be formed so that they become almost equal to the tube-diameter of straight portions 101a1 through 101a4, and 101a1′ through 101a4′.

The leadwire drawn out from the outside glass tube 101A and the inside glass tube 101B in the lamp base 108 is connected to the lamp base pin.

A resistance to vibration of the fluorescent lamp 100 can be improved by filling buffer substance such as silicone resin in the gap g between the outside glass tube 101A and the inside glass tube 101B.

Now, lighting operation of the fluorescent lamp in this embodiment will be explained The fluorescent lamp 100 is operated at the condition that the lamp input power is 40 W or more, the lamp current is 200 A or more, the wall load is 0.05 W/cm² or more, and the lamp efficiency is 50 lm/W or more. By the way, it is usually suitable that the fluorescent lamp 100 is operated at the condition that the lamp input power is 60 W or more, the lamp current is 380 A or more, the wall load is 0.05 W/cm² or more, and the lamp efficiency is 90 lm/W or more. The lamp current densities per unit in the straight portions 101a1 through 101a4, 101a1′ through 101a4′ are 75 mA/cm² or more. Although the temperature of the glass tube 101 rises up to 80 degree-C., the mercury vapor pressure becomes proper state, since the coldest portion of an optimum temperature is formed. Thereby high lamp efficiency is obtained.

FIG. 7 is a plan showing another embodiment of the fluorescent lamp according to the present invention. This embodiment is provided with double-circular shape the same as tho embodiment shown in FIG. 6. However, the former differs from the latter in that the the lamp base 108 of the former is mounted on a center of the side of square, like the embodiment as shown in FIG. 4. The discharge path runs between the lamp base mounted ends of the straight portions 101b, 101b′ of the outside glass tube 101A and the inside glass tube 101B through the tubule 101e connecting the straight portions 101b, 101b.

Hereafter, the embodiment concerning the present invention will be explained. In this embodiment, folding was carried out for the glass tube in which the phosphor coating is formed, and the state of the phosphor coating at that time was observed. In order to comparison, a phosphor coating of the comparative sample was also observed.

Hereafter, the forming conditions of the phosphor coating will be explained In this embodiment, the phosphor coating is formed by applying to the inner wall of the glass tube the phosphor slurry containing a predetermined binder which consists of metal oxide fine particles, such as alumina, boric acid of 0.5 mass % to the mass of a phosphor coating, and then calcinated. The quantity of the phosphor slurry in this embodiment was 4.3 mg/cm².

In the comparative sample, the phosphor coating is formed by applying to the inner wall of the glass tube the phosphor slurry which does not contain boric acid, and then alcinated. The quantity of the phosphor slurry concerning the comparative sample was 4.5 mg/cm². Folding was carried out for the glass tube with which the phosphor coating of the embodiment and the comparative sample were formed, respectively, and the states of the phosphor coatings were observed, respectively.

Now, a result of observation will be described. In this embodiment, cracks and/or peels were hardly observed in the phosphor coating. On the other hand, in the comparative sample cracks and/or peels were seriously observed in the phosphor coating. From the comparison result, it was confirmed that when phosphor slurry containing boric acid is used, the cracks and/or peels of the phosphor coating in the folded portion were inhibited.

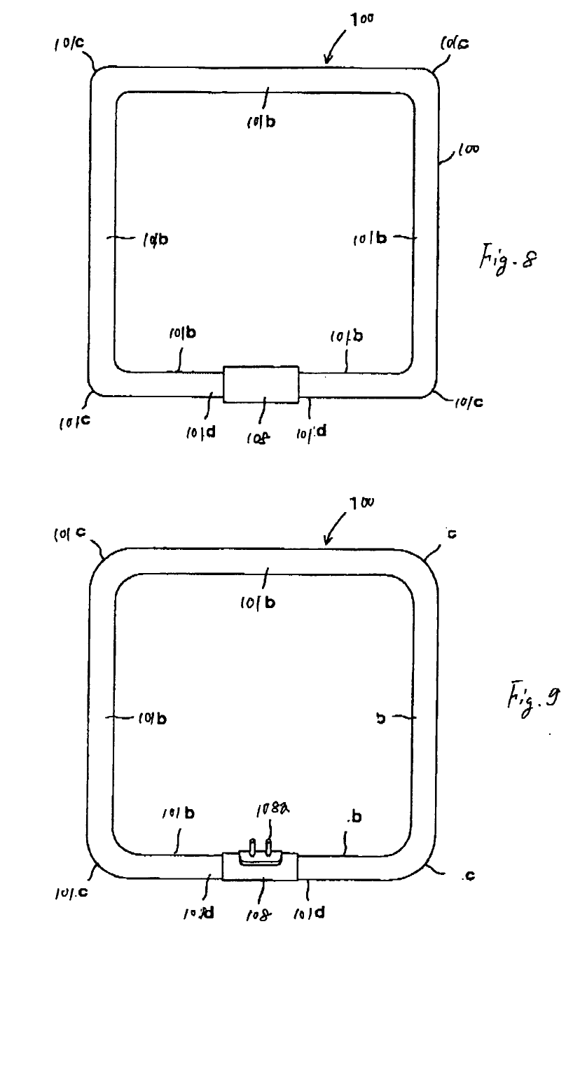

Referring now to FIG. 8, another embodiment of the present invention will be explained. FIG. 8 is a plan showing the embodiment The lamp base 108 of this embodiment is the same as that of the embodiment of FIG. 1 except that the lamp base 108 is mounted on the center of a side of the square.

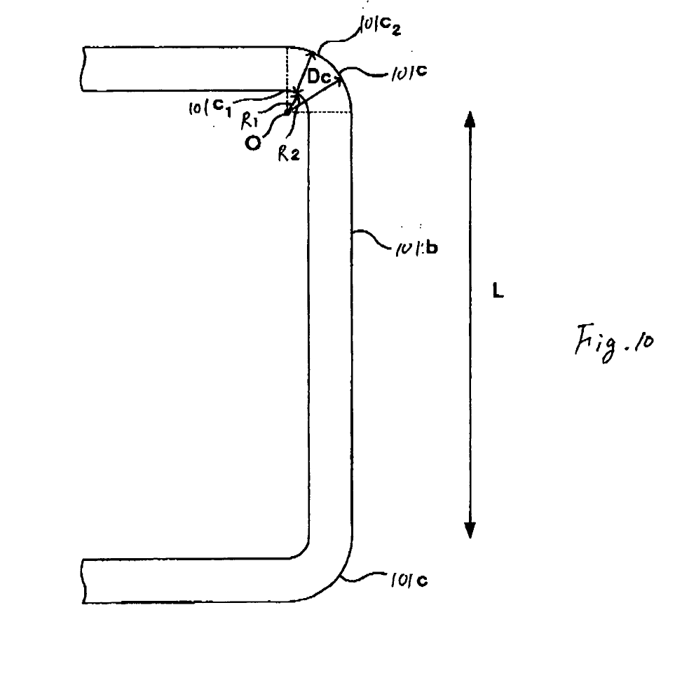

Referring now to FIG. 9, still another embodiment of the present invention will be explained. FIG. 9 is a plan showing this embodiment. This embodiment optimizes the fluorescent lamp shown in FIG. 8. This embodiment is the same as the embodiment shown in FIG. 8 except the constitutions of the folded portion 101c and the lamp base 108.

In this embodiment, the length of the straight portions of the glass tube 101 are 300 mm, and the lamp electric power of the fluorescent lamp 100 is approximately 40 W, and the the lamp current is 300 mA. It is possible to make a high power lighting in that the lamp current is set to 380 mA, and the lamp electric power is set to approximately 50 W, by adjusting an inverter circuit.

In the lamp current of the fluorescent lamp 100 being 300 mA, the lamp operates with the lamp power of approximately 30 W when the length of the straight portion is 225 mm, the lamp operates with the lamp power of approximately 50 W when the length of the straight portion is 375 mm, and the lamp operates with the lamp power of approximately 60 W when the length of the straight portion is 450 mm. When the length of the straight portion is set to 500 mm and the lamp current is set to 380 mA, it is possible to obtain a fluorescent lamp with high luminance and high efficieny for applications to grid ceilings lightings for use of office ceiling.

The lamp base 108 bridges over the end portions 102d, 102d facing each other so as that their axises make a line, and positions around the center of a side of the glass tube 101. The lamp base 108 consists of a cylindrical resin body, and has four lamp base pins 107 projecting therefrom, which act as electric supply section. The lamp base pins 107 incline by about 45 degrees from the principal plane of the glass tube 101 toward the center side of the glass tube 101.

The lamp base 108 is mounted to the end portions 102d and 102d of the glass tube 101 in rotatable within approximately ±45 degrees around the axis of the glass tube 101 with a rotation limiter. The rotation limiter can be realizable by providing protrusions on predetermined positions of the inner surface of the lamp base 108, which cause the lamp base 108 to interfere with the end portions 102d, 102d of the glass when the rotation angle exceeds a certain angle. However, the structure of the rotation limiter is not limited. When the lamp base 108 is constituted in rotatable exceeding a predetermined angle, the outer-leadwire connecting the lamp base pin 107 and the electrode 104 is deformed by tension, and thus there is a fear that two outer-leadwires are short-circuited in the lamp base 108. Therefore, the rotation range must be limited in an adequate angle.

FIG. 10 is a plan expanding and showing some fluorescent lamps of FIG. 9. The folded portion 101c is shaped in a correct angle by mold-shaping, after the glass tube 101a is folded.

As shown in FIG. 10, folded portion 101c is so formed so that the center O of the curvature radius R1 of the inside surface 101c1 and the curvature radius R2 of the outside surface 101c2 take the same position. The inside surface 101e1 of the folded portion 101c is the surface facing the center of the square defined by the square-shaped glass tube 101. And the outside surface 101c2 of the folded portion 101c is the surface facing the outerior of the glass rube 101.

The curvature radius R1, R2 are defined by radiuses of the curves along the inside surface 102e1 and the outside surface 102c2. They roughly correspond to the radiuses of inside surface and the outside surface of the folded portion 102c. The optimal curvature radius R1 is in the range of 13 to 20 mm, and the optimal curvature radius R2 is in the range of 25 to 45 mm. In this embodiment, the curvature radius R1 is 15 mm, and the curvature radius R2 is 31.5 mm.

The tube-diameter Dc of the straight portion 101e is made to become approximately the same as the tube-diameter Db of the adjascent folded portion 101a. Since the folded portion 101c is formed in such a curvature, it is so observed that the folded portion 101c of the square-shaped glass tube 101 of the square-shaped glass tube 101 continuously curves from the straight portion 102b. Thus, the appearance of the fluorescent lamp improves. Since local cold portions do not occur, a coldest portion is hardly formed. Therefore, blackening and stain, etc. by aggregated mercury are hardly occur in the folded portion 101c. In this embodiment, either of the tube-diameter Dc and the tube-diameter Db of straight portion 101a is 16.5 mm. The length L of the straight portion 101a is 237 mm.

Now, the feature of the fluorescent lamp 100 in this embodiment will be explained. As a result of investigations to balance the luminance of the fluorescent lamp and easiness of forming the folded portion 101c, the inventors have found that the length L of the straight portion 101a is desirably in the range of 150-500 mm, and relation between the curvature radius R1 of the inside surface 101c1 of the folded portion 101c and the length L is desirably in the range of 0.03÷R1/L≦0.3 c.

When the length L of the straight portion 101a is in the range of 150 to 500 mm, and ratio R1/L of the curvature radius R1 of the inside surface of the folded portion 101c and the length L of the straight portion 101a is less than 0.03, the deformation degree of the curvature of the folded portion 101c becomes too large, and thus the folded glass becomes undesirably difficult and also the intensity of the folded portion undesirably lowers.

When the ratio R1/L exceeds 0.3, the folded portion takes a large length in the square-shaped glass tube. Accordingly, the heat deterioration of the phosphor coating 103 in folded portion 101c will become intense and a lamp efficiency will fall In the fluorescent lamp 100 of this embodiment, the length L of the straight portion 101a is 237 mm which falls in the range of 150 to 500 mm, and the curvature radius R1 of the inside surface 101c of folded portion 101c is 15 mm Therefore, the ratio R1/L becomes to approximately 0.06 which satisfies the above relation, 0.03≦R1/L≦0.3.

Thus, according to the fluorescent lamp of this embodiment, it is observed that the folded portion 101c of the glass tube 101 continuously curves from the straight portion 101a. Thus, the appearance of the fluorescent lamp improves. Furthermore, components and appliances of lighting appliance can be applied without any inhibition, since other square-shaped glass tubes are not placed inside the glass tube 101.

Further, not only the forming of the folded portion becomes easy, but also a heat deterioration of the phosphor coating 103 of the folded portion 101c is inhibited so as that the illumination from the straight portion 101a can be effectively used.

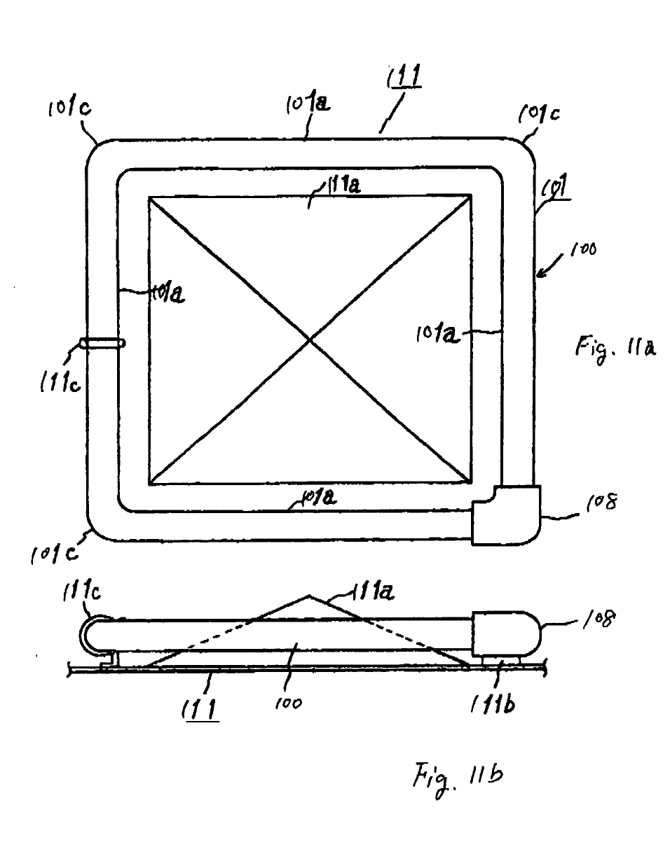

FIGS. 11a and 11b are plan and side elevation views showing one embodiment of the lighting appliance according to the present invention. In FIGS. 11a and 11b, the same elements as those shown in FIG. 1 are assigned with same reference numerals and omitted the explanations. A ceiling attachment type lighting appliance consists of the lighting appliance main body 111, a fluorescent lamp 100, and a high frequency lighting circuit.

The lighting appliance main body 111 is used having been attached in the ceiling, and is provided with white reflector 111a, lamp-socket 111b, lamp-holder 111c, etc. White reflector 111a is configured in the undersurface center of the lighting appliance main body 111, and is making pyramidal shape. Lampsocket 111b works as a connector for supplying electric power to the fluorescent lamp 100. This lamp-socket 111b is attached in the position facing the lamp base 108 of the fluorescent lamp 100. The lamp-holder 111c holds the fluorescent lamp 100 by cross-sectionally supporting the glass tube 101 of the fluorescent lamp.

Te fluorescent lamp 100 is the same as the fluorescent lamp shown in FIG. 1. A lamp base 108 is connected to the lamp-socket 111b, and the predetermined position of the lighting appliance main body 111 is equipped with the fluorescent lamp 100 by holding the glass tube 101 on the lamp-holder 111e.

A high frequency lighting circuit (not shown) for converting a low frequency AC power to a high frequency AC power and supplying the high frequency AC power to the fluorescent lamp 100 via the lamp-socket 111b is located in the back space of the white reflector 111c in the lighting appliance main body 111.

Since a pyramid-shape reflector 113 of the lighting appliance main body 111 is placed in the center of the square-shaped fluorescent lamp 100, the luminous intensity distribution on a plane right under thereof becomes quadrangle. Thereby, luminous intensity distribution is optimal to uniformly illuminate a square room.

Referring now to FIG. 12, another embodiment of the lighting appliance according to the present invention will be explained. FIG. 12 is a plan showing this embodiment. In this embodiment, a set of the square-shaped fluorescent lamps as shown in FIG. 1 is used for mounting to the lighting appliance as shown in FIG. 11. The lighting appliance is the same as that shown in FIG. 11 excepting the fluorescent lamps. Therefore, the lighting appliance is omitted in FIG. 12. Two or more fluorescent lamps are mounted according to the shape of a lighting appliance main body, or the optical characteristics of a lighting appliance.

In the lighting appliance, two square-shaped fluorescent lamps 100a, 100b are concentrically mounted to the lighting appliance main body 111 so as that the respective centers of the square-shaped glass tubes 101a, 101b coincide, and corresponding folded portions of the glass tubes is aligned on a line extending from the center, and the centers of the curvature radius of the folded portions 101c overlap at one point. That is, two square-shaped fluorescent lamps 100a, 100b are concentrically mounted so that the centers of the curvature radiuses R1a of the inside surface 101c1 and the curvature radiuses R2a of the outside surface 101c2 of the small size fluorescent lamp 100a and the centers of the curvature radiuses R1b of the inside surface 101c1 and the curvature radiuses R2b of the outside surface 101c2 of the large size fluorescent lamp 100b overlap at one point.

The space left between the folded portions 101c, 101c of the adjoining fluorescent lamps 100a, 100b becomes almost the same with the space left between the straight portions when the curvature centers of the folded portions 101a, 101a of the fluorescent lamps 100a, 100b attached to the lighting appliance are made to coincide with each other, since two different size fluorescent lamps are mounted so that curvature centers of the folded portions overlap at one point. Thereby, an appearance of the lighting appliance is improved and the light intensities of the fluorescent lamps are uniformized. The fluorescent lamps to be mounted may be another type that the ends of the glass tube face to each other at one corner of square each other at a corner of quadrangle, as shown in FIG. 1.

The phosphor coating of the fluorescent lamp may be formed by applying a mixture of a solution of a proper quantity of phosphate and a binder such as a borate salt, a caking medium such as an ammonium poly-metaacrylatc (APMA), a phosphor and a fine metal oxide particles on the inner wall of the glass tube. Generally a “proper quantity” is the range of 0.05 to 0.5 mass %, for example, 0.3 mass %. The phosphate or the borate do not fuse at the time of calcining of the phosphor coating 103, but fuse in forming the folded portion 101c by heating, and fix the phosphor coating 103 to glass wall. Since such a phosphor coating is formed with a solution with high caking capacity, it may inhibit the crack in the folded portion. Therefore, there is no necessity of using the protective coating, in this case. There are potassium phosphate (KPO₃), boric acid potassium (K₂O₂.(B₂O₃).5H₂O), etc. in the phosphate and borate which act as a binder.

The present invention in its broader aspects is not limited to the specific details and representative embodiments shown and described herein. For example, in the embodiment, although the fluorescent lamp of substantially square form is explained, the present invention may apply the fluorescent lamp which has the straight portion and the folded portion, for example, a straight glass tube, to all the fluorescent lamps formed by being partially folded.

According to the first aspect of the present invention, the protective coating and phosphor coating in the folded portion of the glass tube stop being able to produce cracks and/or peels easily.

According to the second aspect of the present invention, a heat deterioration at the time of forming the folded portions can be reduced.

According to the third aspect of the present invention, the visible light transmittance of the protective coating may be improved.

According to the fourth aspect of the present invention, the visible light transmittance of the protective coating may be improved the same.

According to the fifth aspect of the present invention, a visible light transmittance may be maintained good and cracks and/or peels of the protective coating and a phosphor coating may be lessened.

According to the sixth aspect of the present invention, similarly, cracks and/or peels of the protective coating and a phosphor coating may be lessened.

According to the seventh aspect of the present invention, the appearance of the folded portion is maintainable good.

According to the eighth aspect of the present invention, the glass tube of the glass tube may be protected from mercury, and cracks and/or peels of the protective coating in the folded portion of the glass tube and a phosphor coating may be prevented.

According to the ninth aspect of the present invention, luminous efficiency may be made high and the cracks and/or peels of a phosphor coating in the folded portion may be inhibited.

According to the tenth aspect of the present invention, luminous efficiency may be made high and the cracks and/or peels of a phosphor coating in the folded portion may be inhibited certainly.

According to the eleventh aspect of the present invention, a lighting appliance provided with either of the fluorescent lamps is obtained.

While there have been illustrated and described what are at present considered to be preferred embodiments of the present invention, it will be understood by those skilled in the art that various changes and modifications may be made, and equivalents may be substituted for elements thereof without departing from the true scope of the present invention. In addition, many modifications may be made to adapt a particular situation or material to the teaching of the present invention without departing from the central scope thereof. Therefore, it is intended that the present invention not be limited to the particular embodiment disclosed as the best aspect contemplated for carrying out the present invention, but that the present invention includes all embodiments falling within the scope of the appended claims.

The foregoing description and the drawings are regarded by the applicant as including a variety of individually inventive concepts, some of which may lie partially or wholly outer the scope of some or all of the following claims. The fact that the applicant has chosen at the time of filing of the present application to restrict the claimed scope of protection in accordance with the following claims is not to be taken as a disclaimer or alternative inventive concepts that are included in the contents of the application and could be defined by claims differing in scope from the following claims, which different claims may be adopted subsequently during prosecution, for example, for the purposes of a divisional application.

1. A fluorescent lamp, comprising:
a glass tube having the glass tube diameter of 12-20 mm which is formed on an endless shape as a whole by being partially folded,
the protective coating formed on the inner wall of the glass tube, the coating containing a mixture of large particles with a mean particle size not less than 1.0 μm and fine particles with a mean particle size in the range of 10 to 100 nm;
a phosphor coating formed on the protective coating;
a pair of electrodes mounted in both ends of the glass tube; and
a discharge medium filled in the glass tube.

2. A fluorescent lamp as claimed in claim 1, wherein the length of the glass tube is in the range of 700 to 3000 mm and the partially folded portion has an angle of approximately 90 degrees and a curvature radius at inside the outer surface of the glass tube in the range of 10 to 45 mm, so as that the glass tube is square-shaped.

3. A fluorescent lamp as claimed in any one of claims 1 and 2, wherein the large particles are made of at least one of an alkaline earth metallic salt and a phosphor.

4. A fluorescent lamp as claimed in any one of claims 1 and 2, wherein the fine particles are made of a metal oxide.

5. A fluorescent lamp as claimed in any one of claims 1 and 2, wherein the large particles are of a strontium phosphate and the fine particles are made of a γ-alumina.

6. A fluorescent lamp as claimed in any one of claims 1 and 2, wherein a mass ratio of the large particles and the fine particles is given by an equation, 0.1≦a/(a+b)≦0.5 wherein “a” represents the mass of the large particles and “b” represents the mass of the fine particles.

7. A fluorescent lamp as claimed in any one of claims 1 and 2, wherein a mass ratio of the large particles and the fine particles is given by an equation, 0.15≦a/(a+b)÷0.4 wherein “a” represents the mass of the large particles and “b” represents the mass of the fine particles.

8. A fluorescent lamp as claimed in any one of claims 6 and 7, wherein a quantity of the fine particles is in the range of 0.05 to 2 mg/cm².

9. A fluorescent lamp, comprising:
a glass tube having the glass tube-diameter of 12-20 mm which is formed on an endless shape as a whole by being partially folded;
a phosphor coating formed on the inner wall of the glass tube by applying a phosphor slurry containing fine phosphor particles and boric acid of 0.1 to 1.0 mass % to the mass of the fine phosphor particles to the inner wall of the glass tube, and then calcining the coating;
a pair of electrodes mounted in both ends of the glass tube; and
a discharge medium filled in the glass tube.

10. A fluorescent lamp as claimed in claim 9, wherein a quantity of the fine phosphor particles is in the range of 4.0 to 8.0 mg/cm².

11. A lighting appliance, comprising:
a lighting appliance main body;
a fluorescent lamp as defined in any one of claims 1 to 10 which is attached to the lighting appliance main body; and
a high frequency lighting circuit for lighting the fluorescent lamp by applying thereto a high frequency voltage of not less than 10 kHz.
